(19) United States
(12) Patent Application Publication
(10) Pub. No.: US 2015/0197422 A1
(43) Pub. Date: Jul. 16, 2015

(54) METHOD FOR PROCESSING A GAS STREAM BY ABSORPTION

(71) Applicant: TOTAL RAFFINAGE CHIMIE, Coubevoie (FR)

(72) Inventors: Deyanira Ricaurte Ortega, Pau (FR); Catherine Leroi, Pau (FR); Sébastien Rifflart, Dunkerque (FR); Denis Oules, Montardon (FR)

(21) Appl. No.: 14/391,286

(22) PCT Filed: Apr. 8, 2013
(86) PCT No.: PCT/FR2013/050762

§ 371 Date: Mar. 25, 2015

(30) Foreign Application Priority Data
Apr. 10, 2012 (FR) 1253272

(51) Int. Cl. C01B 3/52; B01D 53/14

(52) U.S. Cl. CPC C01B 3/52; B01D 53/1462; B01D 53/1475; B01D 53/1468; B01D 53/1425; B01D 53/1493; C01B 2203/0415; B01D 2252/204

(57) ABSTRACT

A process for purifying a synthesis gas containing at least 50% of a mixture of CO and of H₂ and from 10% to 50% of acidic gases is described herein. In an embodiment the process for purifying a gas comprises at least 50% by volume of a mixture of CO and of H₂ and from 10% to 50% by volume of an acidic gas chosen from CO₂, H₂S and a mixture of CO₂ and of H₂S, comprising a step (a) consisting in contacting the gas with a washing solvent so as to absorb acidic gas in the washing solvent, and a step (b) consisting in recovering, on the one hand, a purified gas stream, and, on the other hand, the spent washing solvent, the washing solvent comprising at least one compound of formula CH₃—(OCH₂)n-O—CH₃, n being between 1 and 20.

### TECHNICAL FIELD OF THE INVENTION

The present invention relates to a process for purifying a synthesis gas containing at least 50% of a mixture of CO and of H₂ and from 10% to 50% of acidic gases.

### PRIOR ART

Synthesis gas, also known as syngas, is a gaseous mixture of carbon monoxide (CO) and of hydrogen (H₂) in variable proportion. It also very often contains acidic gases. The term “acidic gases” means carbon dioxide (CO₂) and hydrogen sulfide (H₂S). Synthesis gas may also optionally contain carbon oxysulfide (COS), ammonia (NH₃), hydrogen cyanide (HCN), methane (CH₄), nitrogen (N₂) and water (H₂O).

Processes for removing acidic gases by washing with a solvent are conventionally used for partially or totally removing CO₂ and H₂S from synthesis gas. These processes generally consist in introducing the gas to be treated into the bottom of a washing tower and a washing solvent into the top. The purified gas leaves the washing tower via the top, while the solvent used, which has absorbed the acidic gases, leaves the washing tower via the bottom.

By way of example, mention may be made of three commercial processes currently used for removing acidic gases in synthesis gas.

The Rectisol® process uses methanol as solvent. This compound has a very high vapour pressure, which makes it highly volatile. To limit the losses of methanol by evaporation, it is thus necessary to work at very low temperatures (as low as −70° C.) or to install water washing towers. This represents one of the main drawbacks of this technology, since the cooling system is energy-intensive and the equipment to be envisaged in order to work at these temperatures is expensive.

In the Selexol® process, the solvent used is polyethylene glycol dimethyl ether (PGDME), which has a very low vapour pressure, making it sparingly volatile and thus limiting the losses by evaporation.

The relative solubility of H₂S in PGDME is much higher than that of CO₂. The Selexol® process is thus based on a double absorption with two columns functioning in a cycle: the first column takes up the H₂S, while the second column takes up the CO₂.

The regeneration of the solvent used in the second column takes place by several flash distillations, by successive depressurizations or by withdrawal by an inert gas such as air or nitrogen. The traces of water, of HCN and possibly of mercaptans may thus be removed at that time.

The equipment required for performing a Selexol® process is relatively inexpensive. However, the energy consumption of this process is high due to the high viscosity of the solvent. The high viscosity of the solvent has the consequence of making the heat and matter transfers difficult, which reduces the efficacy of the exchange plates. It is therefore necessary to increase the throughput of the solvent.

Finally, in the Purisol® process, N-methyl-2-pyrrolidone (NMP) is used as solvent. This solvent has a selectivity towards the absorption of H₂S relative to CO₂ that is higher than that of other solvents. The essential object of this process is therefore to take up H₂S. It has a higher vapour pressure than that of PGDME; it is therefore necessary either to use a refrigeration system, which has the drawback of being very energy intensive, or to install water washing towers in order to limit the losses of solvent by evaporation. In this case, it is not possible to obtain a dry treated gas.

The schematic diagram is similar to that for the Selexol® process with two washing columns: one for the absorption of H₂S and one for the absorption of CO₂.

Finally, NMP catalyses the hydrolysis of carbon oxysulfide (COS): it is therefore an advantageous solvent for taking up sulfur-bearing products.

Other processes have been described in the literature. European patent application EP 2 380 653 describes a gas purification system. This purification system uses, inter alia, a washing solvent which may be polyethylene glycol dimethyl ether (PGDME) as in the Selexol® process. American patent U.S. Pat. No. 4,044,100 describes a process for separating acidic gases from a gaseous mixture using a liquid solvent comprising diisopropanolamine and a polyalkylene glycol dialkyl ether, most particularly a polyethylene glycol dimethyl ether (PGDME). Finally, European patent application EP 0 362 023 concerns a process for treating a gas containing methane for the purpose of removing the water, the acidic gases and higher hydrocarbons therefrom. The use of various washing solvents is mentioned. However, none of the documents cited above describes the use of a compound of polyoxymethylene dimethyl ether type.

Faced with the high investment and running costs of these processes, there is a need for a process for removing acidic gases for the treatment of a synthesis gas, which is more energy-efficient than the known processes, and which minimizes the above drawbacks, while at the same time maintaining high capacity for absorption of acidic gases, especially of CO₂.

### SUMMARY OF THE INVENTION

It is within this context that the inventors have discovered that it is possible to improve the processes for removing acidic gases by using a novel washing solvent.

One subject of the present invention is a process for purifying a gas comprising at least 50% by volume of a mixture of CO and of H₂ and acidic gases, by using as a washing solvent a compound or a mixture of compounds of formula CH₃—(OCH₂)ₙ—O—CH₃, n being between 1 and 20 and preferably between 2 and 10.

The invention is more precisely directed towards a process for purifying a gas comprising at least 50% by volume of a mixture of CO and of H₂ and from 10% to 50%; by volume of an acidic gas chosen from CO₂, H₂S and a mixture of CO₂ and of H₂S, comprising a step (a) consisting in contacting the gas with a washing solvent so as to absorb acidic gas in the washing solvent, and a step (b) consisting in recovering, on the one hand, a purified gas stream, and, on the other hand, the spent washing solvent, the washing solvent comprising at least one compound of formula CH₃—(OCH₂)ₙ—O—CH₃, n being between 1 and 20.

According to a preferred embodiment, the washing solvent may be a mixture of at least one compound of formula CH₃—(OCH₂)ₙ—O—CH₃, n being between 1 and 20, and of a solvent of the amine family.

### DETAILED DESCRIPTION

It is understood that, in the context of this description, the term “between” should be interpreted as including the indicated limits.

In addition, unless otherwise mentioned, the percentages expressed in the present description are volume percentages.

One subject of the invention is a process for purifying a gas. It may be a process for removing acidic gases from a gas. In the present description, the expression “removing acidic gases” means a treatment for withdrawing at least part, preferably at least 50%, more preferably at least 70%, even more preferably at least 90%, and preferably all of the CO₂ and/or H₂S present in the gas to be treated. The process of the present invention may advantageously be a process for removing CO₂.

The process according to the invention comprises a step (a) consisting in contacting the gas to be treated with a washing solvent so as to absorb acidic gas in the washing solvent, and a step (b) consisting in recovering, on the one hand, a purified gas stream, and, on the other hand, the spent washing solvent, the washing solvent comprising at least one compound of formula CH₃—(OCH₂)ₙ—O—CH₃, n being between 1 and 20.

The gas to be treated is a gas comprising at least 50% by volume, preferably from 50% to 85%, more preferably from 55% to 80% and even more preferably from 60% to 70% of a mixture of CO and of H₂.

In addition, the gas to be treated comprises from 10% to 50% by volume, preferably from 15% to 50%, more preferably from 20% to 50% and even more preferably from 30% to 45% of acidic gas chosen from CO₂, H₂S and a mixture of CO₂ and of H₂S.

Preferentially, the gas to be treated comprises from 10% to 50% by volume, preferably from 15% to 50%, more preferably from 20% to 50% and even more preferably from 30% to 45% of CO₂.

According to one embodiment, the gas to be treated is free of H₂S. The term “free of” in the present application means that the compound is totally absent or that it is present only in trace amount.

According to another embodiment, the gas to be treated also comprises H₂S, preferably at a concentration of between 0.01% and 10% by volume.

The gas to be treated may also comprise at least one other compound chosen from water, COS, NH₃, HCN, CH₄ and N₂, and mixtures thereof.

The gas to be treated may comprise:
from 0 to 1% by volume of COS,
from 0 to 1% by volume of NH₃,
from 0 to 1% by volume of HCN,
from 0 to 1% by volume of CH₄,
from 0 to 1% by volume of N₂, and
water up to the point of saturation of the gas with water.

The compounds of formula CH₃—(OCH₂)ₙ—O—CH₃, used in the process according to the invention, are polyoxymethylene dimethyl ethers, also known as “POM-METHYL”. They are known in the prior art, but for different uses. For example, French patent FR 2 881 750 describes a use of POM-METHYL as fuel for a fuel cell. Moreover, international patent application WO 2010/001 048 describes the use of POM-METHYLs for conserving the human or animal body, for the purposes of embalming.

Moreover, the use of POM-METHYL compounds as agents for trapping carbon oxides has been described in international patent application WO 2012/052 671, which was not published until 26 Apr. 2012. The examples presented in the said application show that compounds of polyoxymethylene type, comprising O—C—O—C alternating atoms, are more efficient in taking up carbon oxides, in particular CO₂, than compounds of diethylene glycol type containing O—C—C—O—C—C alternating atoms. However, the said patent application does not specifically describe a process for purifying a gas comprising at least 50% by volume of a mixture of CO and of H₂ and from 10% to 50%; by volume of an acidic gas chosen from CO₂, H₂S and a mixture of CO₂ and of H₂S.

The synthesis of POM-METHYLs has been known for many years. The book Formaldehydes by J. F. Walker (Robert E. Krieger Publishing Company, Huntington, N.Y., 3rd Edition, 1975) is especially a reference work in this field. A description of the synthetic methods may be found therein on pages 167 et seq., on the one hand, and 264 et seq., on the other hand. These synthetic processes are based on an acid catalysis of the reaction of an alcohol (methanol or ethanol) or of an acetal (methylal or ethylal) with formaldehyde or an equivalent compound. This type of synthesis is also illustrated in many patents, such as U.S. Pat. No. 2,449,469. Other synthetic methods based on a Lewis acid-type catalysis have also been described. Mention may be made of patent GB 1 120 524, which describes the synthesis of stable polyoxymethylene diethers with ionic catalysts of Lewis acid type.

In the present invention, the washing solvent comprises at least one POM-METHYL compound for which n is between 1 and 20. Preferably, n is between 2 and 10. The washing solvent may comprise a mixture of POM-METHYL compounds for which n is between 1 and 20 and preferably between 2 and 10.

The washing solvent may thus comprise at least one compound chosen from 2,4,6-trioxaheptane (i.e. POM-METHYL in which n=2), 2,4,6,8-tetraoxanonane (i.e. POM-METHYL in which n=3), 2,4,6,8,10-pentaoxaundecane (i.e. POM-METHYL in which n=4), 2,4,6,8,10,12-hexaoxatridecane (i.e. POM-METHYL in which n=5), 2,4,6,8,10,12,14-heptaoxapentadecane (i.e. POM-METHYL in which n=6), 2,4,6,8,10,12,14,16-octaoxaheptadecane (i.e. POM-METHYL in which n=7), 2,4,6,8,10,12,14,16,18-nonaoxanonadecane (i.e. POM-METHYL in which n=8), and mixtures thereof. Preferentially, the washing solvent comprises a mixture of the said compounds.

The inventors have discovered, surprisingly, that the POM-METHYL compounds have a higher capacity for absorbing CO₂ than that of the washing solvents conventionally used, for example methanol, PGDME or NMP. In addition, the absorption of CO₂ proved to be highly selective towards CO and H₂. The washing solvent of the present invention advantageously makes it possible to take up efficiently the CO₂ present in the gas to be treated.

In addition, the POM-METHYL compounds have, at room temperature, a low viscosity when compared with the solvents of the prior art. They may thus be used advantageously in processes for removing acidic gases under operating conditions that are less restrictive than in the processes using the solvents of the prior art.

Moreover, the POM-METHYL compounds are inoffensive and do not give rise to any environmental or health problems.

According to one embodiment, the washing solvent may consist of a mixture of POM-METHYL compounds for which n is between 1 and 20 and preferably between 2 and 10.

However, surprisingly, it has been demonstrated that the POM-METHYL compounds could advantageously be combined with solvents of the amine family to improve the H₂S-absorbing capacity. It was found that the addition of such solvents does not affect the CO₂-absorbing capacity.

This is why the washing solvent in the present invention may also comprise a solvent of the amine family, preferably of the alkanolamine family. This solvent of the alkanolamine family may preferably be chosen from the group consisting of monoethanolamine (MEA), 2-aminoethoxyethanol, also known as diglycolamine (DGA), diisopropanolamine (DIPA), diethanolamine (DEA), methyldiethanolamine (MDEA), triethanolamine (TEA) and sterically hindered amines, and mixtures thereof.

Even more preferably, the tertiary amines may be activated, as is known by those skilled in the art. Hydroxyethylpiperazine and piperazine are known in particular as activators of tertiary amines. The solvent of the amine family may then be a mixture of methyldiethanolamine (MDEA) and of primary or secondary amines, in particular hydroxyethylpiperazine or piperazine.

When the washing solvent comprises one or more POM-METHYL compounds and a solvent of the amine family, the mass ratio of the POM-METHYL compounds to the solvent of the amine family is preferably between 50/50 and 90/10, more preferably between 60/40 and 85/15 and even more preferably between 70/30 and 80/20.

The process of the present invention is particularly advantageous insofar as it withstands the presence of water in the gas. Specifically, the inventors have discovered that the CO₂-absorbing capacity of the POM-METHYL compounds was not deteriorated either by the presence of water. The gas to be treated may thus comprise water in an amount ranging up to saturation of the gas with water.

Since water is sparingly soluble in the solvent of the present invention, it is possible to separate out, if necessary, the water by direct decantation of the spent washing solvent, when the temperature of the solvent is greater than 5° C. This is why the process according to the invention may also comprise a step consisting in separating the water from the purified gas stream by decantation.

Step (a) of contacting the gas to be treated with the washing solvent may be performed according to any method known to those skilled in the art. One method may consist in introducing the gas to be treated into the bottom of a washing tower, and in introducing the washing solvent into the top in liquid form. Counter-current circulation of the gas through the liquid solvent ensures a large surface of contact. It is also possible to employ packing columns. During this contacting, the acidic gases, especially CO₂, contained in the gas to be treated are absorbed in the washing solvent.

The capacity for absorption of the acidic gas by the washing solvent depends on the temperature and pressure of the gas to be treated.

The absorption during step (a) may be performed at an absolute pressure ranging from 1 to 80 bar and preferably from 10 to 60 bar.

Furthermore, the absorption during step (a) may be performed at a temperature ranging from −40° C. to +60° C. and preferably from 5° C. to 30° C.

After this step of contacting, a purified gas stream, on the one hand, and the spent washing solvent, on the other hand, may be recovered during step (b) of the process according to the invention.

The purified gas stream advantageously has a concentration of acidic gas, especially of CO₂, of less than 5% by volume and preferably between 0 and 4%.

In addition, the process according to the invention may comprise a step (c) consisting in regenerating the spent washing solvent, by depressurization and optionally by heating, and a step (d) consisting in recovering, on the one hand, a stream of acidic gases, preferably of CO₂, and, on the other hand, regenerated washing solvent.

Advantageously, the majority of the regenerated washing solvent recovered after step (d) according to the invention may be used as washing solvent in step (a).

The inventors have discovered that it is possible to perform the process of the present invention via absorption-regeneration cycles without the capacity for absorbing the acidic gases, and especially CO₂, by the solvent decreasing over time, and this being possible without input or with only a small input of heat energy. Specifically, they have found that the solvent can be regenerated at atmospheric pressure or under vacuum, at room temperature, without the capacity for absorbing the acidic gases, and especially CO₂, of the solvent being affected. It is thus possible to minimize the energy expenditure generally necessary for the regeneration of the washing solvent.

Advantageously, the depressurization during step (c) may be performed at an absolute pressure ranging from 0.3 to 1.1 bar, and preferably at atmospheric pressure. Thus, it is not necessary to expend energy in order to create a vacuum.

Furthermore, advantageously, the depressurization during step (c) may be performed at a temperature ranging from 0 to 150° C. When the washing solvent consists of POM-METHYL compounds, the depressurization temperature is preferentially between 10° C. and 30° C., more preferentially between 15° C. and 25° C. and even more preferentially at room temperature. When the washing solvent consists of a mixture of POM-METHYL compounds and of solvents of the amine family, the depressurization temperature is preferentially between 20° C. and 150° C. and more preferentially between 30° C. and 120° C. If the depressurization temperature is higher than the boiling point of the washing solvent, a solvent recovery device, for example a condenser, may be added to the washing equipment so as to limit the losses by recovering the evaporated solvent.

Step (c) for regenerating the spent washing solvent may be performed according to any standard method known to those skilled in the art.

According to one embodiment, step (c) comprises several depressurizations.

After step (c), a stream of acidic gas, on the one hand, and regenerated washing solvent, on the other hand, may be recovered during step (d) of the process according to the invention. The stream of recovered acidic gas may advantageously comprise CO₂, H₂S or a mixture of these two gases, in a content of at least 98% by volume.

According to one embodiment, steps (c) and (d) may be repeated successively two or more times. Thus, the regenerated washing solvent recovered during step (d) may again be regenerated by depressurization during a new step (c). Steps (c) and (d) may be repeated as many times as necessary to obtain a washing solvent having the desired purity.

In addition, the spent washing solvent, recovered during step (b), may itself optionally be subjected to a washing step, with the same washing solvent, so as to remove certain compounds, before optionally being regenerated.

In one particular embodiment of the present invention, the gas purification process is repeated successively two or more times. Thus, the purified gas stream recovered during step (b) may again be contacted with a washing solvent according to step (a).

When the process is repeated several times, the washing solvent used in each step (a) may be the same or different. However, it is preferred for these solvents to be the same so as to be able to be recycled in one or the other of the washing steps.

The spent washing solvent, recovered during each step (b), may be regenerated during a step (c) and recovered according to a step (d), as described in the present invention.

In another particular embodiment of the present invention, when the gas to be treated comprises H₂S, the process also comprises a step (a′) consisting in at least partly removing the H₂S present in the gas to be treated, before contacting the gas with the washing solvent.

This embodiment is particularly suited to the case where the gas to be treated comprises from 0.01% to 10% by volume of H₂S.

Step (a′) may be performed according to any standard method known to those skilled in the art. In particular, step (a′) may consist, like step (a), in contacting the gas to be treated with a second washing solvent, according to the known techniques.

According to a first embodiment, the washing solvent may be one of those known to a person skilled in the art for this purpose.

However, according to a second advantageous embodiment, the second washing solvent may comprise at least one POM-METHYL compound for which n is between 1 and 20 and preferably between 1 and 10. The second washing solvent may be chosen from those described previously.

The second washing solvent may also advantageously comprise a solvent from the amine family, preferably from the alkanolamine family. This solvent from the alkanolamine family may preferably be chosen from the group consisting of monoethanolamine (MEA), 2-aminoethoxyethanol, also known as diglycolamine (DGA), diisopropanolamine (DIPA), diethanolamine (DEA), methyldiethanolamine (MDEA), triethanolamine (TEA) and sterically hindered amines, and mixtures thereof.

Even more preferably, the tertiary amines may be activated, as is known to those skilled in the art. Hydroxyethylpiperazine and piperazine are known in particular as activators of tertiary amines. The solvent of the amine family may then be a mixture of methyldiethanolamine (MDEA) and of primary or secondary amines, in particular hydroxyethylpiperazine or piperazine.

The first and second washing solvents may be different in the same process for removing acidic gases. However, it is preferred for these two solvents to be the same in order to be able to be recycled in one or the other of the washing steps.

When the gas to be treated comprises a mixture of CO₂ and of H₂S, the process according to the invention advantageously allows selective separation of these two gases via two successive washing towers.

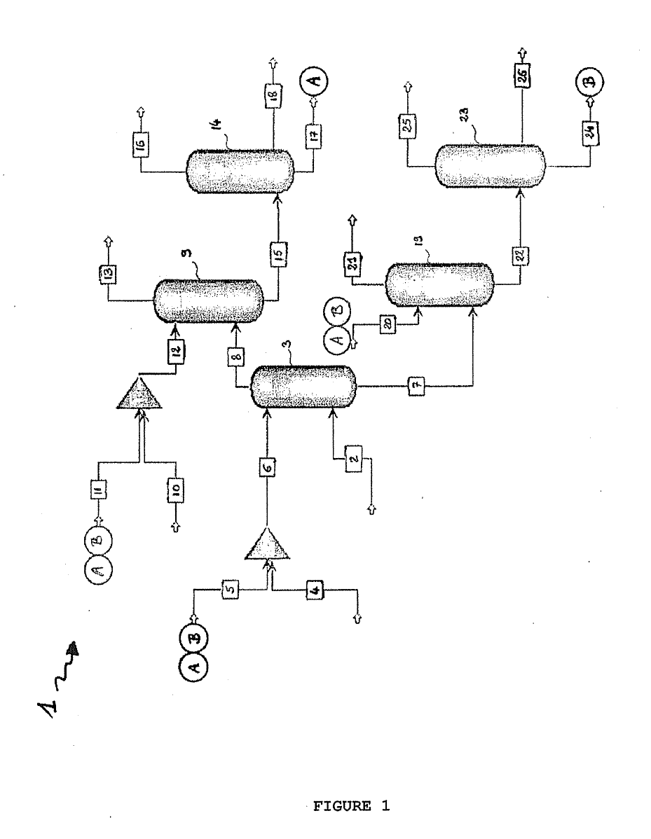

The invention is now described in greater detail and in a non-limiting manner by reference to a particular embodiment represented in FIG. 1.

FIG. 1 diagrammatically represents an embodiment of equipment for performing the process according to the invention.

FIG. 1 represents equipment 1 for performing the process for purifying a gas conveyed via line 2. This gas to be treated comprises CO₂, CO and H₂ predominantly, possibly with H₂S, CH₄, N₂ and water.

The equipment 1 comprises an H₂S separation unit 3. This unit 3 is a unit for washing with a washing solvent comprising at least one compound of POM-METHYL type, optionally combined with a compound of amine type (for example MDEA or DEA). It may comprise a contactor in the form of a column. Such a deacidification unit may also be provided with its own system for regenerating washing solvent.

The washing solvent used in the unit 3 comes from two sources: it is composed of fresh solvent coming from line 4 and of regenerated solvent A and/or B coming from line 5.

The gas to be treated entering the process is introduced into the unit 3 via line 2 and the washing solvent via line 6. The majority of the H₂S that may be contained in the gas to be treated is absorbed by the washing solvent in the unit 3 and the washing solvent rich in H₂S is recovered at the outlet via line 7. The gas to be treated, which is depleted in H₂S, leaves via line 8 and is conveyed to a CO₂ separation unit 9.

The separation unit 9 is a unit for washing with a washing solvent comprising at least one compound of POM-METHYL type, optionally combined with a compound of amine type (for example MDEA or DEA). It may comprise a contactor in the form of a column. This unit is also provided with a system for regenerating the absorbing solution.

Unit 9 is fed with liquid phase via line 12 which comprises the fresh washing solvent 10 and regenerated washing solvent A and/or B coming from line 11.

The CO₂ separation unit 9 is fed with gas to be treated via the H₂S-depleted gas coming from unit 3, via line 8, and with washing solvent via line 12.

In unit 9, the majority of the CO₂ contained in the gas to be treated is absorbed by the washing solvent. At the outlet of unit 9, the purified gas stream is recovered via line 13, while the spent washing solvent, charged with CO₂, is conveyed to the regeneration unit 14 via line 15.

The regeneration unit 14 recovers the CO₂ gas contained in the solvent charged with CO₂ leaving unit 9. The CO₂ is recovered via line 16. The regenerated solvent A is recovered from unit 14 via line 17 and it may be conveyed to units 3 and/or 9 and/or 19. The water potentially present in the washing solvent may be separated out and recovered via line 18, for example by decantation.

The equipment also consists of a selective regeneration unit 19 which recovers the CO₂ contained in the liquid absorbent coming from the H₂S separation unit 3, via line 7. It is fed with washing solvent by means of the recycling of the solvent A and/or B coming from units 14 and/or 23 via line 20.

The CO₂ is recovered at the outlet of unit 19 via line 21 and the partially regenerated solvent, depleted in CO₂, leaves unit 19 via line 22 and is conveyed to a final regeneration unit 23.

In this unit 23, the H₂S is separated from the absorbent liquid and leaves via line 25. The solvent is regenerated (regenerated solvent B) and leaves via line 24. It is conveyed to units 3 and/or 9 and/or 19. The water potentially present may be separated out and recovered via line 26.

Other characteristics and advantages of the invention will emerge on reading the non-limiting and purely illustrative examples that follow, taken in combination with the attached drawings, in which:

FIG. 2 is a diagram illustrating the degree of absorption of CO₂ as a function of the pressure by the compound POM-METHYL(2,8) at different temperatures. The absorption capacity is given in Nl/kg on the y-axis and the absolute pressure on the x-axis.

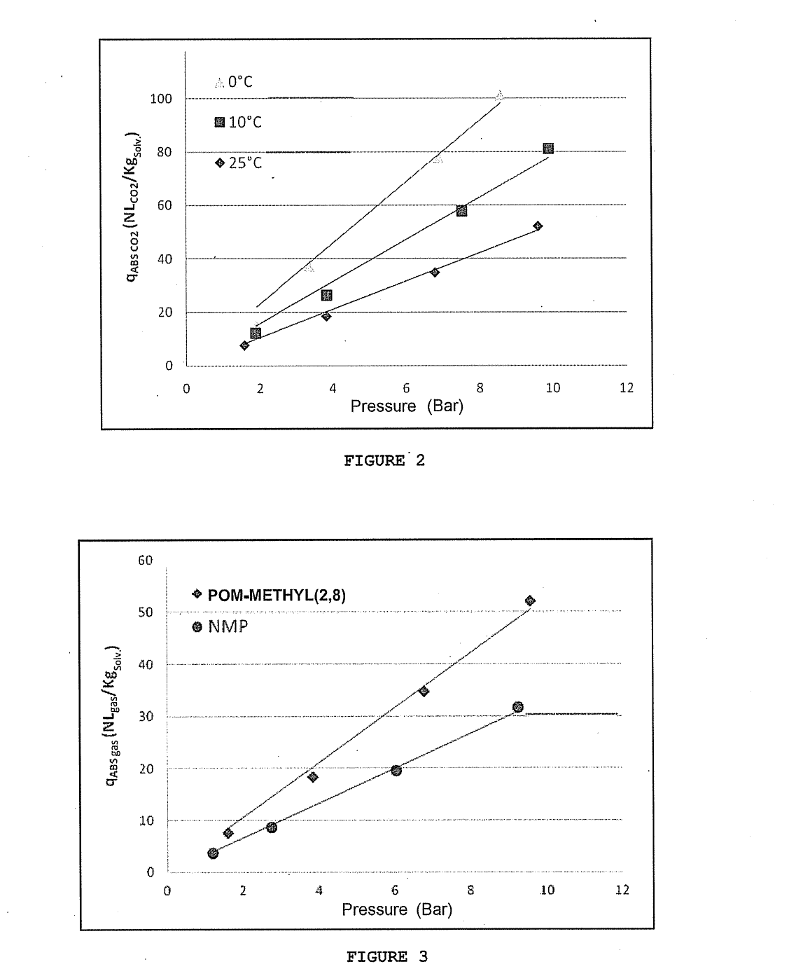

FIG. 3 is a diagram illustrating the degree of absorption of CO₂ as a function of the pressure by the compound POM-METHYL(2,8) and by NMP. The absorption capacity is given in Nl/kg on the y-axis and the absolute pressure on the x-axis.

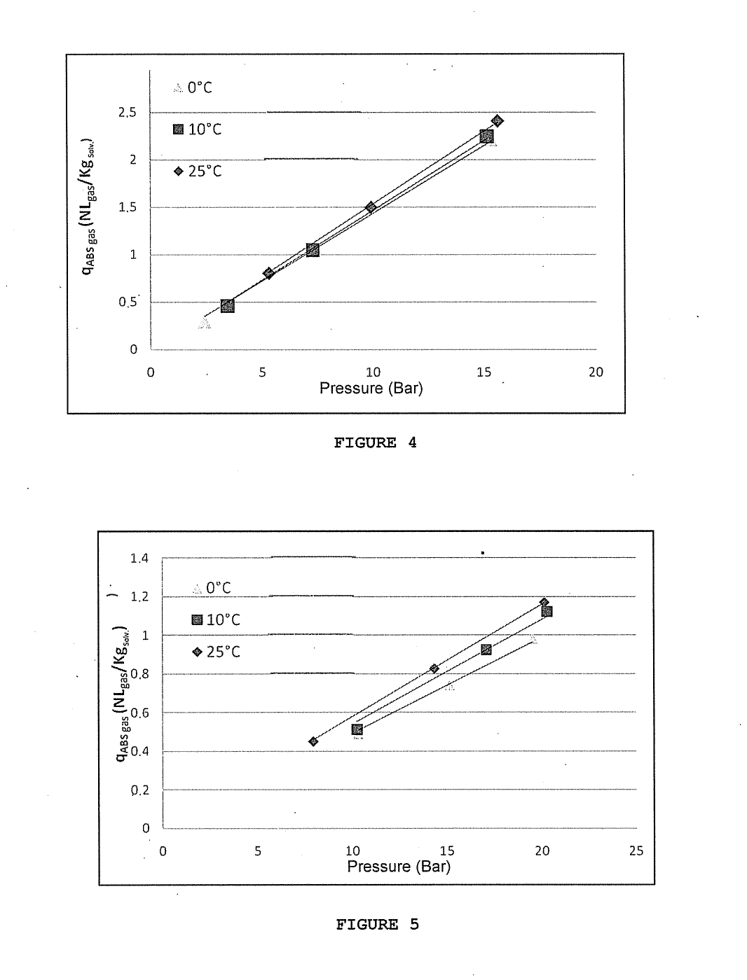

FIG. 4 is a diagram illustrating the degree of absorption of CO as a function of the pressure by the compound POM-METHYL(2,8) at different temperatures. The absorption capacity is given in Nl/kg on the y-axis and the absolute pressure on the x-axis.

FIG. 5 is a diagram illustrating the degree of absorption of H₂ as a function of the pressure by the compound POM-METHYL(2,8) at different temperatures. The absorption capacity is given in Nl/kg on the y-axis and the absolute pressure on the x-axis.

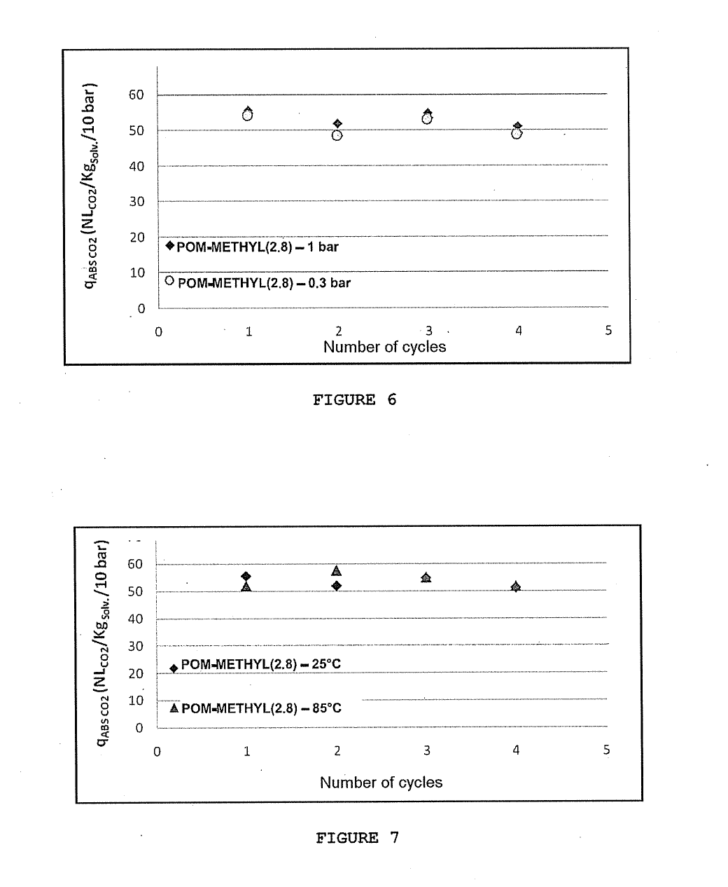

FIG. 6 is a diagram illustrating the absorption-regeneration cycles of the absorbent compound (POM-METHYL(2,8)). The regenerations were performed at 25° C. at atmospheric pressure, and also at 25° C. at an absolute pressure of 0.3 bar. The absorption capacity is indicated on the y-axis in Nl/kg at 10 bar (absolute pressure). The number of cycles is given on the x-axis.

FIG. 7 is a diagram illustrating the absorption-regeneration cycles of the absorbent compound (POM-METHYL(2,8)). The regenerations were performed at 25° C. at atmospheric pressure, and also at 80° C. at atmospheric pressure. The absorption capacity is indicated on the y-axis in Nl/kg at 10 bar (absolute pressure). The number of cycles is given on the x-axis.

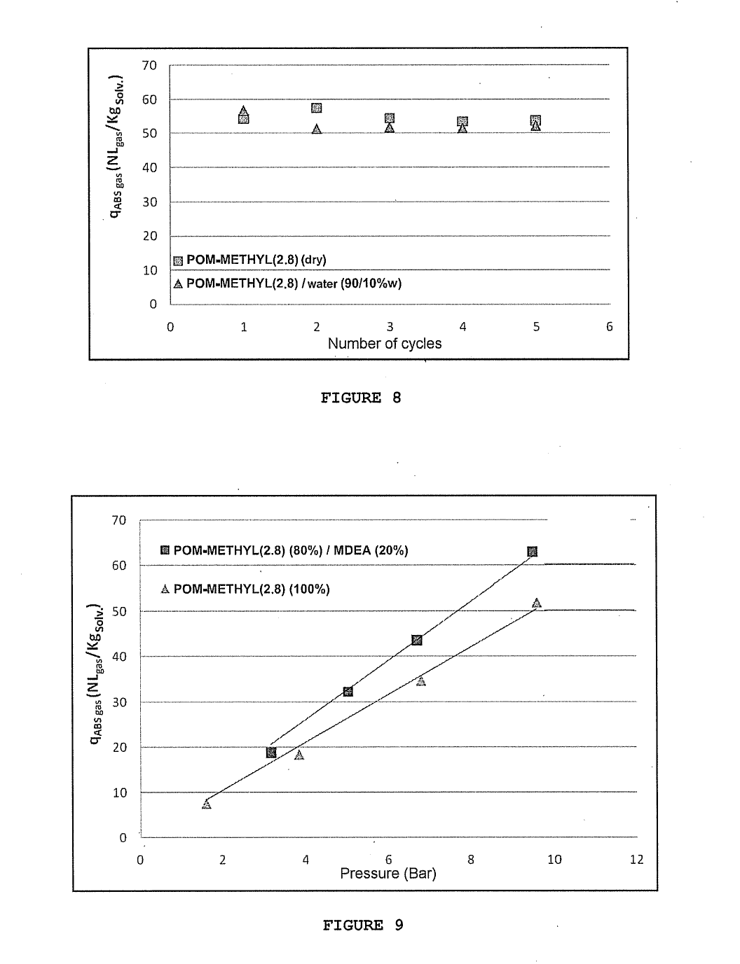

FIG. 8 is a diagram illustrating the degree of absorption of CO₂ in a wet gas stream with the compound POM-METHYL(2,8) and also the regeneration of this stream. The absorption capacity is indicated on the y-axis in Nl/kg at 10 bar (absolute pressure). The number of cycles is given on the x-axis. The regenerations were performed at 25° C. and at atmospheric pressure.

FIG. 9 is a diagram illustrating the CO₂-absorbing capacity by a mixture of compounds POM-METHYL(2,8) (80%) and MDEA (20%). The absorption capacity is given in Nl/kg on the y-axis and the absolute pressure on the x-axis.

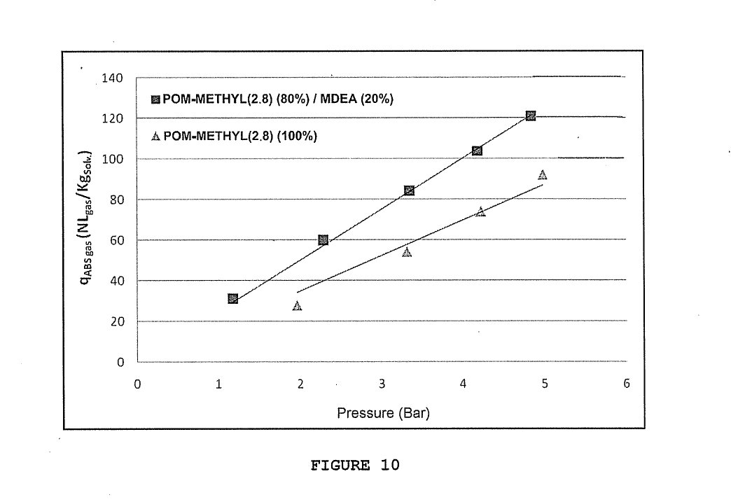

FIG. 10 is a diagram illustrating the H₂S-absorbing capacity with a mixture of compounds POM-METHYL(2,8) (80%) and MDEA (20%). The absorption capacity is given in Nl/kg on the y-axis and the absolute pressure on the x-axis.

### EXAMPLES

The measurements were taken using a laboratory absorption pilot unit. A certain amount of the washing solvent was placed in a 1 L reactor. The small amount of air present in the atmosphere was removed by placing the reactor under vacuum by means of a vacuum pump. The gas on which it was desired to take the measurements was stored in a 1 L flask. A certain amount of this gas was sent to the reactor. The reactor and the flask, and also their communication lines, were equipped with pressure and temperature sensors.

The reactor was stirred. The pressure reduction in the reactor indicates the absorption of the gas by the solvent. It is thus possible, via this method, to calculate the amount of gas absorbed by the solvent, and thus the gas-absorbing capacity of the solvent, as a function of the pressure at a given temperature.

Once the pressures were stable, it was considered that the solvent was saturated. The absorption process was then stopped.

In all the experiments, the absorption time was unified at 1 hour.

In the text hereinbelow, POM-METHYL(2,8) denotes the washing solvent comprising a mixture of compounds of formula CH₃—(OCH₂)ₙ—O—CH₃, n ranging from 2 to 8.

### Example 1

### CO₂-Absorbing Capacity of POM-METHYL(2,8)

The CO₂-absorbing capacity of POM-METHYL(2,8), at different temperatures and pressures, was measured according to the protocol described above, and the results are given in FIG. 2.

It is found that the temperature has a large effect on the solubility of CO₂ in this solvent.

The CO₂-absorbing capacity of other solvents conventionally used for the removal of acidic gases is reported in Table 1:

TABLE 1

| | Solvent (25° C.) | | | |
|---|---|---|---|---|
| | Selexol | Purisol | Rectisol | POM- |
| | (PGDME) | (NMP) | (MeOH) | METHYL(2,8) |
| CO₂-Abs. capacity | 3.22 | 3.34 | 3.68 | 5.26 |
| (Nl gas/kg solv./bar) | | | | |

It is found that the CO₂-absorbing capacity of POM-METHYL(2,8) is between 1.4 and 1.6 times greater than the CO₂-absorbing capacity of the other standard solvents.

The CO₂-absorbing capacity of NMP at 25° C. was measured according to the protocol described above, for various pressures, and the results are given in FIG. 3.

It is found that, irrespective of the pressure, the CO₂-absorbing capacity of POM-METHYL(2,8) is higher than the CO₂-absorbing capacity of NMP.

### Example 2

### CO₂ Absorption Selectivity of POM-METHYL(2,8)

The CO— and H₂-absorbing capacity of POM-METHYL(2,8), at different temperatures and pressures, was measured according to the protocol described above, and the results are given, respectively, in FIG. 4 and FIG. 5.

It is found that the CO— and H₂-absorbing capacities are low relative to the values obtained with CO₂, independently of the temperature.

The selectivity of POM-METHYL(2,8) is thus validated.

Moreover, the temperature does not have a large effect on the CO— and H₂-absorbing capacities of this solvent.

As specifically regards H₂, it is noted, however, that the absorption capacity decreases slightly as the temperature decreases, which is contrary to the behaviour observed with CO₂. This may be advantageous, since it means that the selectivity improves at low absorption temperatures.

### Example 3

### Effect of the Pressure on the Regeneration of the Solvent

The CO₂-absorbing capacity of POM-METHYL(2,8) was measured according to the protocol described above, and the solvent was then regenerated by depressurization. The absorption-regeneration cycle was repeated a certain number of times. At each cycle, the CO₂-absorbing capacity of POM-METHYL(2,8) was remeasured.

The absorptions were performed at a temperature of 25° C. and at an absolute pressure of 10 bar. The regenerations were performed at 25° C. at atmospheric pressure, and also at 25° C. at an absolute pressure of 0.3 bar. The results are given in FIG. 6.

It is found that the regeneration pressure does not have a very large impact on the regeneration of the solvent, which is an important advantage for the solvent.

### Example 4

### Effect of the Regeneration Temperature of the Solvent

In the same manner as in the preceding example, the CO₂-absorbing capacity of POM-METHYL(2,8) was measured according to the protocol described above, and the solvent was then regenerated. The absorption-regeneration cycle was repeated a certain number of times. On each cycle, the CO₂-absorbing capacity of the POM-METHYL(2,8) was remeasured.

The absorptions were performed at a temperature of 25° C. and at an absolute pressure of 10 bar. The regenerations were performed at atmospheric pressure at 25° C., and also at 85° C. The results are given in FIG. 7.

It is found that the regeneration temperature does not have a very large impact on the regeneration of the solvent, which is an important advantage for the solvent.

### Example 5

### Effect of the Presence of Water on the Regeneration of the Solvent

In the same manner as in the preceding example, the CO₂-absorbing capacity of POM-METHYL(2,8) was measured according to the protocol described above, and the solvent was then regenerated by depressurization. The absorption-regeneration cycle was repeated a certain number of times. On each cycle, the CO₂-absorbing capacity of the POM-METHYL(2,8) was remeasured.

The absorptions were performed at a temperature of 25° C. and at an absolute pressure of 10 bar. The regenerations were performed at atmospheric pressure at 25° C. The results are given in FIG. 8.

The solvent was used pure in one case, and in another case as a mixture with water (90% by mass of POM-METHYL(2,8) and 10% by mass of water).

It is found that the presence of water has little impact on the CO₂-absorbing capacity.

### Example 6

### Effect of the Addition of MDEA to the Solvent POM-METHYL(2,8)

In the same manner as in Example 1, the CO₂-absorbing capacity of POM-METHYL(2,8) was measured at 25° C. at different pressures.

In the first case, the POM-METHYL(2,8) was used pure, and in the second case, the POM-METHYL(2,8) was mixed with MDEA (80% by mass of POM-METHYL(2,8) and 20% by mass of MDEA). The results are given in FIG. 9.

It is found that the presence of MDEA does not have a negative impact on the CO₂-absorbing capacity of the solvent.

Moreover, the H₂S-absorbing capacity of pure POM-METHYL(2,8), on the one hand, and of a mixture of POM-METHYL(2,8) and of MDEA (80% by mass of POM-METHYL(2,8) and 20% by mass of MDEA), at 25° C. at different pressures, was measured according to the protocol described above, and the results are given in FIG. 10.

It is found that MDEA improves the H₂S-absorbing capacity.

1. Process for purifying a gas comprising at least 50% by volume of a mixture of CO and of H₂ and from 10% to 50% by volume of an acidic gas chosen from CO₂, H₂S and a mixture of CO₂ and of H₂S, comprising
(a) contacting the gas with a washing solvent so as to absorb acidic gas in the washing solvent, and
(b) recovering, on the one hand, a purified gas stream, and, on the other hand, the spent washing solvent, the washing solvent comprising at least one compound of formula CH₃—(OCH₂)n-O—CH₃, n being between 1 and 20.

2. Process according to claim 1, characterized in that n is between 2 and 10.

3. Process according to claim 1, wherein the washing solvent also comprises a solvent from the amine family, preferably from the alkanolamine family, preferably chosen from the group consisting of monoethanolamine (MEA), 2-aminoethoxyethanol also known as diglycolamine (DGA), diisopropanolamine (DIPA), diethanolamine (DEA), methyldiethanolamine (MDEA), triethanolamine (TEA) and sterically hindered amines, and mixtures thereof.

4. Process according to claim 1, wherein the gas to be treated comprises from 10% to 50% by volume, preferably from 15% to 50%, more preferably from 20% to 50% and even more preferably from 30% to 45% of CO₂.

5. Process according to claim 1, wherein the gas to be treated also comprises H₂S, preferably at a concentration of between 0.01% and 10% by volume.

6. Process according to claim 1, wherein the absorption during step (a) is performed at an absolute pressure ranging from 1 to 80 bar and preferably from 10 to 60 bar.

7. Process according to claim 1, wherein the absorption during step (a) is performed at a temperature ranging from −40° C. to +60° C. and preferably from 5° C. to 30° C.

8. Process according to claim 1, wherein the process also comprises
(c) regenerating the spent washing solvent, by depressurization and optionally by heating, and
(d) recovering, on the one hand, a stream of acidic gases, preferably of CO₂, and, on the other hand, regenerated washing solvent.

9. Process according to claim 8, characterized in that the majority of the regenerated washing solvent recovered after step (d) is used as washing solvent in step (a).

10. Process according to claim 1, wherein, when the gas to be treated comprises H₂S, the process further comprises at least partly removing the H₂S present in the gas to be treated, before contacting the gas with the washing solvent.
